(19) United States
(12) Patent Application Publication
(10) Pub. No.: US 2015/0134393 A1
(43) Pub. Date: May 14, 2015

(54) ENHANCED CONTROL TO USERS IN PLACEMENT OF TASKS ALONG A TIMELINE

(71) Applicant: Oracle International Corporation, Redwood Shores, CA (US)

(72) Inventors: NILADRI SEKHAR DE, Hyderabad (IN); Srinivasu Dudala, Hyderabad (IN); Surya Vedula, Hyderabad (IN)

(73) Assignee: Oracle International Corporation, Redwood Shores, CA (US)

(21) Appl. No.: 14/080,786

(22) Filed: Nov. 14, 2013

(51) Int. Cl. G06Q 10/10

(52) U.S. Cl. CPC G06Q 10/1097
USPC 705/7.21

(57) ABSTRACT

An aspect of the present disclosure provides enhanced control to users in the placement of tasks along timelines. In an embodiment, task data specifying details of multiple tasks scheduled along a timeline, is maintained. The tasks are displayed along the timeline. A candidate position is received for a first task along the timeline. In response, the task data is examined to identify a set of tasks scheduled in a time slice covering the candidate position, and data related to identified set of tasks is collected. The collected data is then sent for display, for example, in a viewport associated with the first task.

### BACKGROUND OF THE DISCLOSURE

1. Technical Field

The present disclosure relates to task management systems and more specifically to providing enhanced control to users in placement of tasks along a timeline.

2. Related Art

A task generally refers to an activity to be performed. There are often situations when organizations are required to perform multiple related tasks, for example, as part of a project. The tasks may be related for the overall objective, or due to the tasks being required to be performed in sequence, parallel, etc.

A timeline provides a common reference to indicate relevant time instances such as start and finish dates/times, in which corresponding tasks are performed. The timeline can be at a level of granularity (e.g., by minutes, hours, half-days, days, months, etc.), as suitable in the corresponding context.

Placement of a task refers to determination of suitable start/finish dates for the task. Such determination may need to be performed when adding new tasks to a timeline or when moving a pre-existing task to a new location along the timeline.

It is generally desirable that users be provided enhanced control in placement of tasks along timelines.

### BRIEF DESCRIPTION OF THE DRAWINGS

Example embodiments of the present disclosure will be described with reference to the accompanying drawings briefly described below.

FIG. 1 is a block diagram illustrating an example environment in which several aspects of the present invention can be implemented.

FIG. 2 is a flow chart illustrating the manner in which tasks may be placed along a timeline according to an aspect of the present disclosure.

FIGS. 3A-3F together illustrates the manner in which a user is enabled to make a decision on the placement of a task along a timeline in one embodiment.

FIGS. 4A-4C together illustrates the manner in which a user is enabled to move an existing task along a timeline (for example, to accommodate a desired position for a task being placed), in one embodiment.

FIG. 5 illustrates the manner in which a user is provided information on all the tasks in the timeline in one embodiment.

FIG. 6 illustrates the manner in which task data is maintained in one embodiment.

FIG. 7 is a block diagram illustrating the details of a digital processing system in which various aspects of the present disclosure are operative by execution of appropriate executable modules.

In the drawings, like reference numbers generally indicate identical, functionally similar, and/or structurally similar elements. The drawing in which an element first appears is indicated by the leftmost digit(s) in the corresponding reference number.

### DETAILED DESCRIPTION OF THE EMBODIMENTS OF THE DISCLOSURE

### 1. Overview

An aspect of the present disclosure provides enhanced control to users in the placement of tasks along timelines. In an embodiment, task data specifying details of multiple tasks scheduled along a timeline, is maintained. The tasks are displayed along the timeline. A candidate position is received for a first task along the timeline. In response, the task data is examined to identify a set of tasks scheduled in a time slice covering the candidate position, and data related to identified set of tasks is collected. The collected data is then sent for display, for example, in a viewport associated with the first task.

The above features may be performed iteratively for each of a sequence of candidate positions received for the first task, until the user indicates that a last candidate position is a selected position for the task. The task data may be updated to indicate the selected position for the first task. A scheduler may thereafter be executed to determine a final position for the first task, based on the selected position and consistent with other constraints in scheduling all the tasks along the timeline.

By thus providing relevant information for different candidate positions, the user is provided enhanced control in placement of tasks along a timeline.

Several aspects of the present disclosure are described below with reference to examples for illustration. However, one skilled in the relevant art will recognize that the disclosure can be practiced without one or more of the specific details or with other methods, components, materials and so forth. In other instances, well-known structures, materials, or operations are not shown in detail to avoid obscuring the features of the disclosure. Furthermore, the features/aspects described can be practiced in various combinations, though only some of the combinations are described herein for conciseness.

### 2. Example Environment

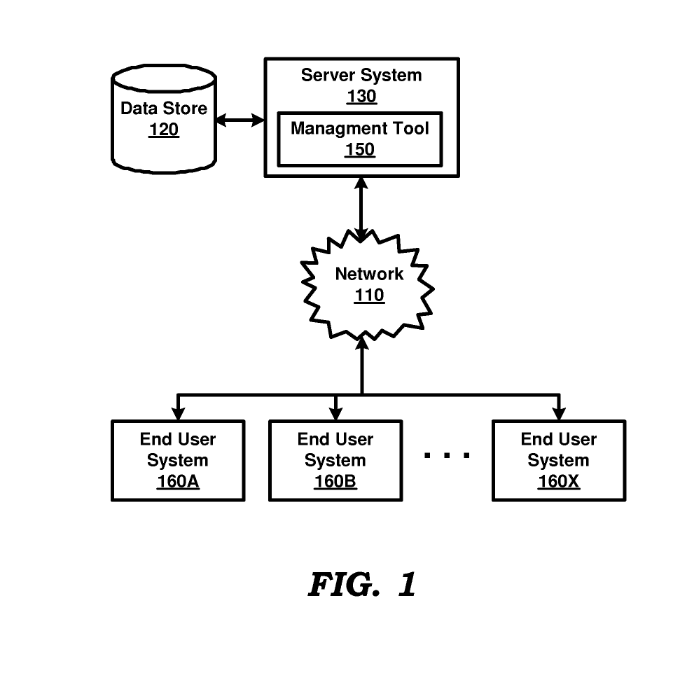

FIG. 1 is a block diagram illustrating an example environment in which several aspects of the present invention can be implemented. The block diagram is shown containing network 110, data store 120, server system 130 (shown executing management tool 150) and end user systems 160A-160X.

Merely for illustration, only representative number/type of systems is shown in the Figure. Many environments often contain many more systems, both in number and type, depending on the purpose for which the environment is designed. Each system/device of FIG. 1 is described below in further detail.

Network 110 provides connectivity between server system 130 and end user systems 160A-160X, and may be implemented using protocols such as Transmission Control Protocol (TCP) and/or Internet Protocol (IP), well known in the relevant arts. In general, in TCP/IP environments, an IP packet is used as a basic unit of transport, with the source address being set to the IP address assigned to the source system from which the packet originates and the destination address set to the IP address of the destination system to which the packet is to be eventually delivered.

A (IP) packet is said to be directed to a destination system when the destination IP address of the packet is set to the (IP) address of the destination system, such that the packet is eventually delivered to the destination system by network 110. When the packet contains content such as port numbers, which specifies the destination application, the packet may be said to be directed to such application as well. The destination system may be required to keep the corresponding port numbers available/open, and process the packets with the corresponding destination ports. Network 110 may be implemented using any combination of wire-based or wireless mediums.

Data store 120 represents a non-volatile (persistent) storage facilitating storage and retrieval of data (such as the original/new values of the start and finish times of the tasks, the resource assigned to each task, the availability of each of the resources, etc.) by applications executing in server system 130. Data store 120 may be implemented as a corresponding database server using relational database technologies and accordingly provide storage and retrieval of data using structured queries such as SQL (Structured Query Language). Alternatively, data store 120 may be implemented as a corresponding file server providing storage and retrieval of data in the form of files organized as one or more directories, as is well known in the relevant arts.

Each of end user systems 160A-160X represents a system such as a personal computer, workstation, mobile station, mobile phones, computing tablets, etc., used by users to generate (user) requests directed to applications executing in server system 130. The user requests may be generated using appropriate user interfaces (for example, web pages provided by applications executing in server system 130).

Server system 130 represents a server, such as a web/application server, executing applications/software based tools (e.g., management tool 150) capable of processing (user) requests received from users using one of end user systems 160A-160X. Server system 130 may use data stored internally (for example, in a non-volatile storage/hard disk within the system), external data (for example, stored in data stores such as 120) and/or data received from external sources (e.g., from the user) in processing of the user requests. The server system then sends the result of processing of the user requests to the requesting end user system (one of 160A-160X).

Management tool 150 represents a project/task management application (executing in server system 130) that enables users to manage tasks based on user requests received from various end user systems 160A-160X. One of common management actions is the placement of tasks. In one common approach to placement, a user is provided the ability to specify respective initial positions for one or more tasks, with the final positions for the tasks thereafter being determined by a scheduler implemented within management tool 150. Schedulers determine the final positions based on various factors such as the effort (e.g., as man-hours/days) required for performing each task, the availability of resources for performance of the tasks, the relationships among the tasks, initial positions of tasks, etc., as is well known in the relevant arts. However, the final positions for tasks may also be determined manually alone, without using schedulers.

Aspects of the present disclosure provide enhanced control to users in placement of tasks along a timeline.

### 3. Placement of Tasks Along a Timeline

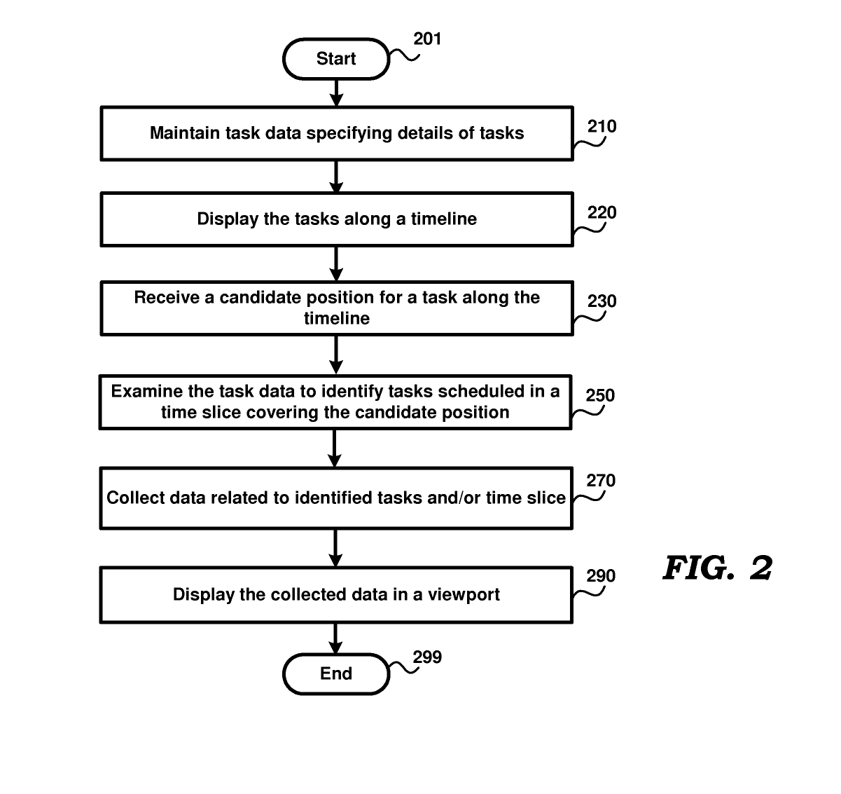

FIG. 2 is a flow chart illustrating the manner in which tasks may be placed along a timeline according to an aspect of the present disclosure. The flowchart is described with respect to the systems of FIG. 1, in particular, management tool 150, merely for illustration. However, the features can be implemented in other systems and environments also without departing from the scope and spirit of various aspects of the present invention, as will be apparent to one skilled in the relevant arts by reading the disclosure provided herein.

In addition, some of the steps may be performed in a different sequence than that depicted below, as suited to the specific environment, as will be apparent to one skilled in the relevant arts. Many of such implementations are contemplated to be covered by several aspects of the present invention. The flow chart begins in step 201, in which control immediately passes to step 210.

In step 210, management tool 150 maintains task data specifying the details (such as the start/finish times, resource allocated, etc.) of various pre-existing tasks scheduled along a timeline. The term ‘scheduled’ implies that the corresponding final position of each pre-existing task is determined by a scheduler (or manually), and the corresponding position on the timeline is indicated by the task data. The task data may be maintained in any convenient format, for example, in a table in data store 120.

In step 220, management tool 150 displays (sends for display) the maintained tasks along the timeline with an appropriate granularity. The tasks may be retrieved from task data and then sent for display in response to a request received from a user using one of end user systems 160A-160X. The tasks and the timeline may then be displayed on a display unit (not shown in FIG. 1) associated with the requesting end user system (assumed to be 160A, for illustration).

In step 230, management tool 150 receives (data indicating) a candidate position for a task along the (displayed) timeline. A candidate position refers to a position (start and finish time) at which the user wishes/proposes to place the task along the timeline. Thus, the candidate position is a temporary position and accordingly not part of (absent in) task data.

The candidate position may be for a new task sought to be added to the timeline or a new proposed position for a pre-existing task (present in the task data) on the timeline. A user may provide the placement (and the details of a new task) using a suitable user interface provided on end user system 160A.

In step 250, management tool 150 examines the task data (maintained in data store 120) to identify tasks scheduled in a time slice covering the candidate position. The time slice thus used, is a duration which starts earlier that the start time of the candidate position and ends later than the finish time of the candidate position. The width/duration of the time slice may be user-specified (e.g., as part of the data received in step 230) or computed dynamically based on various parameters such as the duration of the candidate position, number of pre-existing tasks overlapping with (or nearby to) the candidate position, etc.

In step 270, management tool 150 collects data related to the identified tasks and time slice. In particular, the collected data includes various parameters that assist/support the user in making a decision on the placement of the task. Examples of such decision support parameters are the number/detail of tasks contained in the time slice, the dependencies among the tasks in the time slice, the allocation of (general or specific) resources in the time slice, etc.

In step 290, management tool 150 displays the collected data in a viewport (on the display unit associated with the requesting end user system 160A). A view port refers to a portion (often rectangular) of the display in which information is displayed, as is well known in the arts. The flow chart ends in step 299.

It may be appreciated that a user may place a task at different candidate positions, view (in the viewport) the values of the decision support parameters at the different candidate positions, and then decide the placement of the task at a desired/selected position along the timeline.

The selected position represents the position (start/finish times) at which the task is to be included in the timeline/task data. It is noted that the selected position represents an initial position of the task, and a scheduler may thereafter further refine the placement to a final position along the timeline. Such final position is indicated in the task data of step 210.

However, by providing such relevant information interactively for various candidate positions, users are provided enhanced control in placement of tasks along a timeline. The manner in which management tool 150 may provide such enhanced control to users according to the steps of FIG. 2 is illustrated below with examples.

### 4. Illustrative Examples

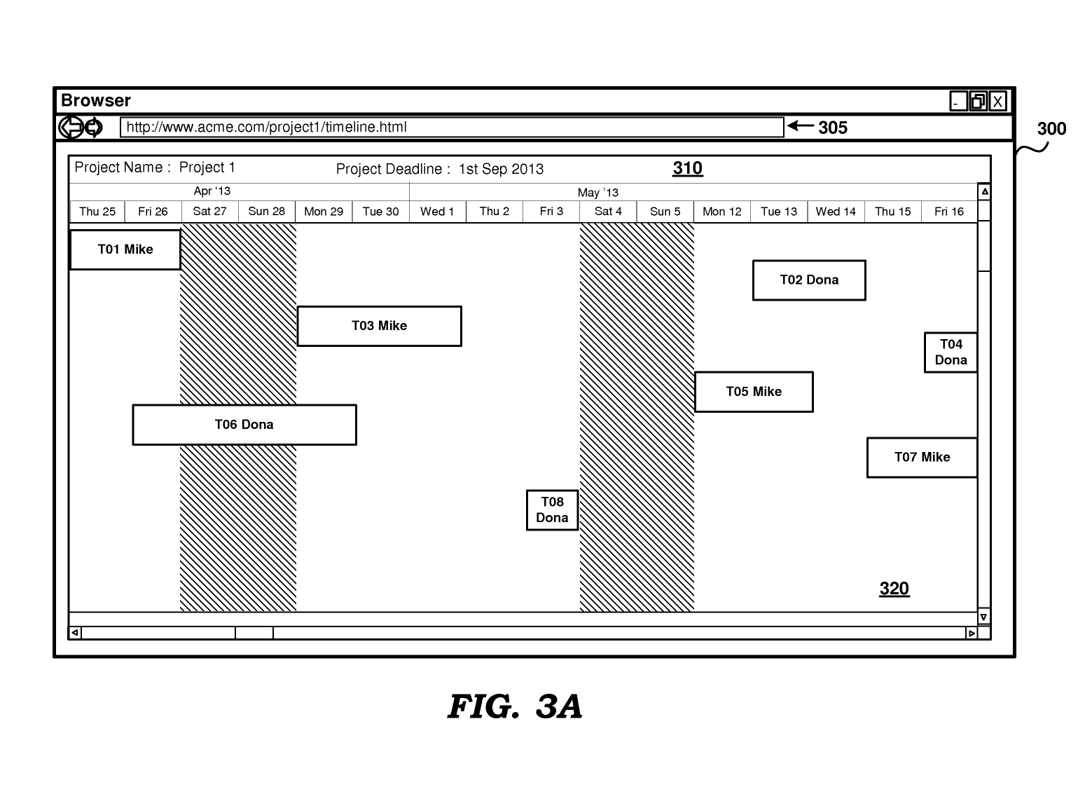

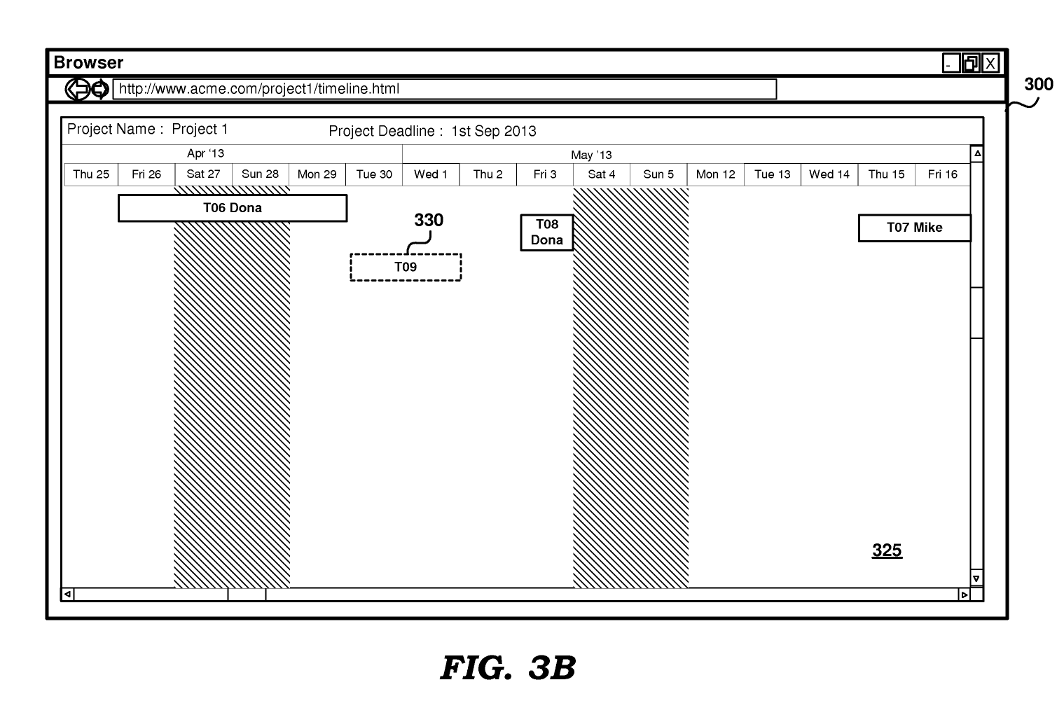

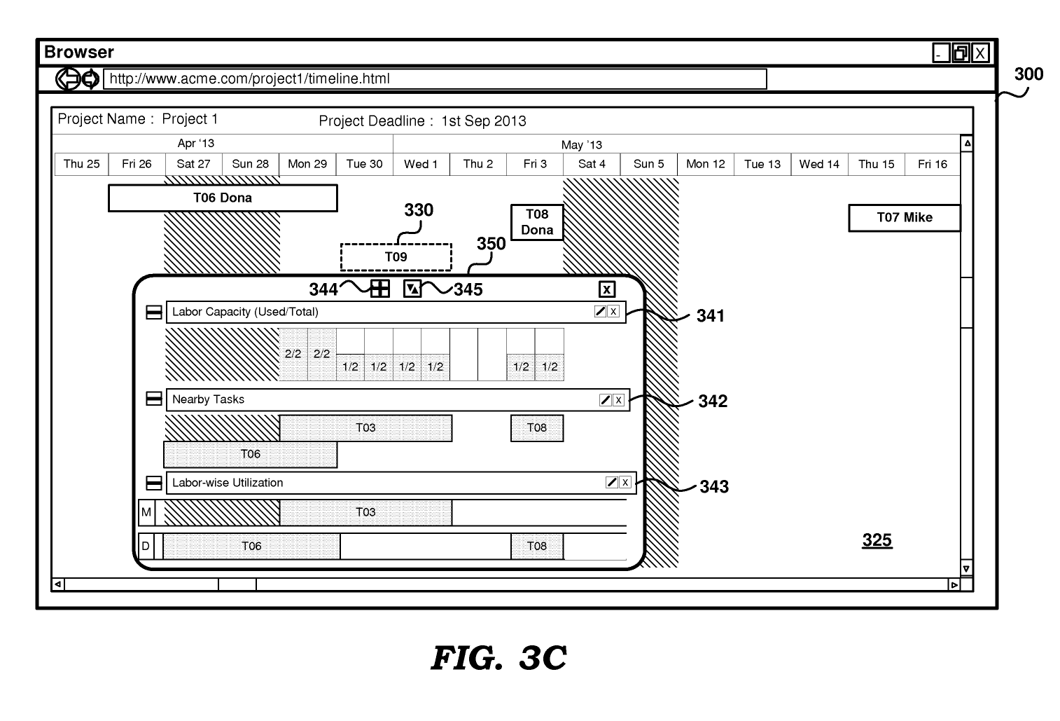

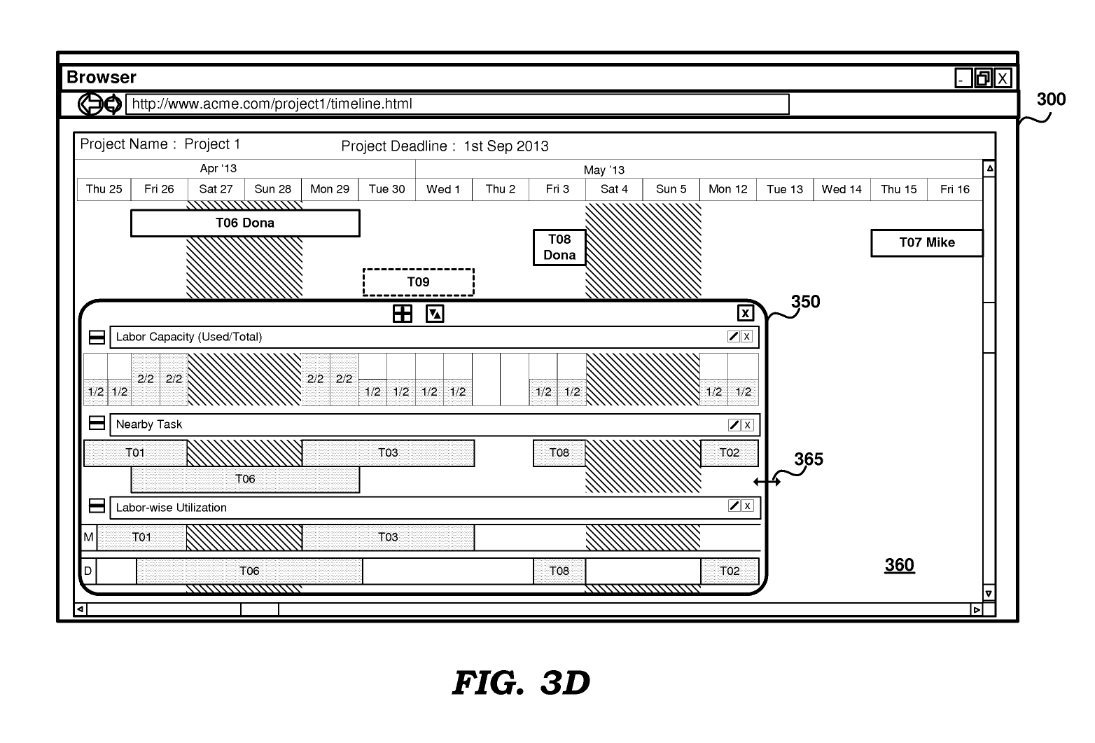

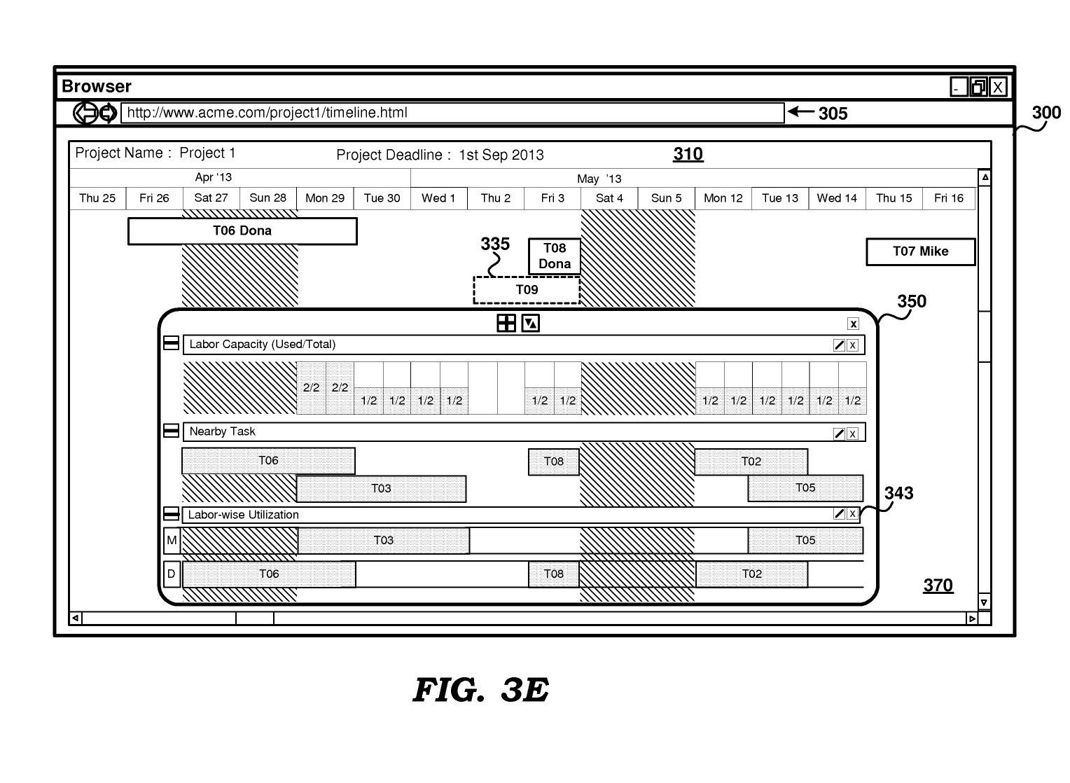

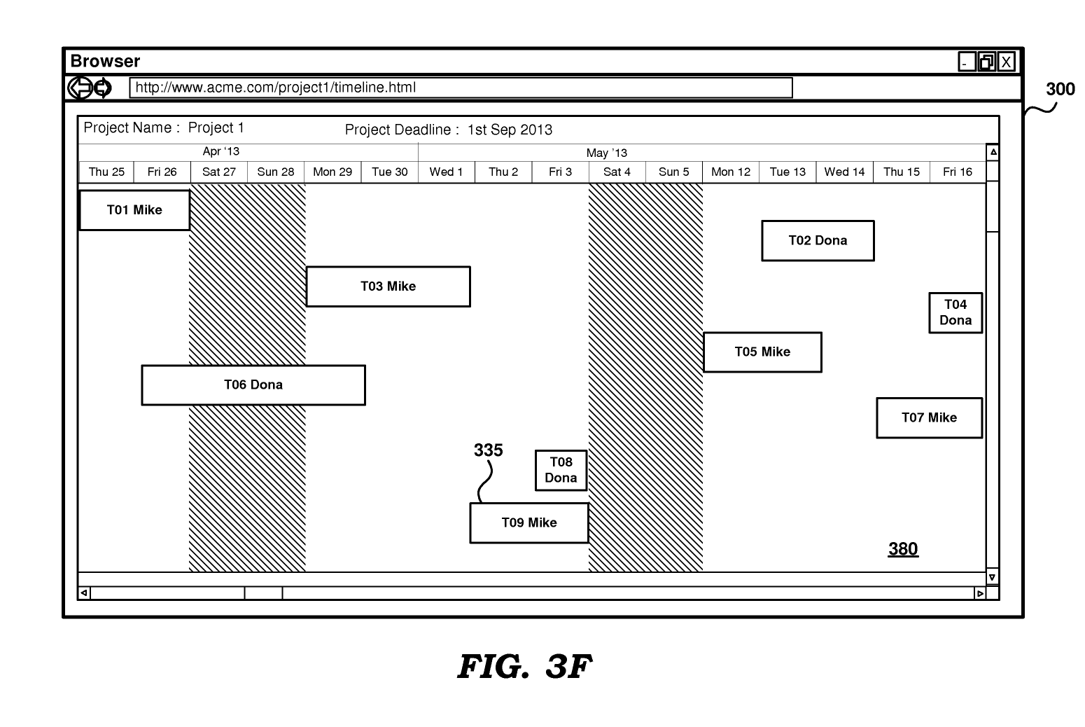

FIGS. 3A-3F, 4A-4C, 5 and 6 together illustrates the manner in which users are provided enhanced control in placement of tasks along a timeline in one embodiment. Each of the Figures is described in detail below.

FIGS. 3A-3F together illustrates the manner in which a user is enabled to make a decision on the placement of a task along a timeline in one embodiment. Display area 300 of FIGS. 3A-3F, 4A-4C and 5 depicts a portion of a user interface provided on a display unit (not shown in FIG. 1) associated with one of end user systems 160A-160X (assumed to be 160A for illustration). In one embodiment, display area 300 corresponds to a webpage accessed by the users using a browser in response to sending a request (including an identifier of the webpage, as indicated by the text in display area 305) from end user system 160A to management tool 150. The web page is received from management tool 150 prior to being displayed (using the browser) on the display unit.

Referring to FIG. 3A, display area 310 indicates that the details of a project named “Project 1” having a project deadline of “1 Sep. 2013” is being displayed in the user interface. It should be noted that several features of the present disclosure are described below with respect to the tasks of a project, for illustration. However, in alternative embodiments, the tasks displayed on the timeline may not form part of a project and may be any set of freeform unstructured tasks/activities that are required to be managed.

Display area 320 provides a timeline of the various tasks in the project. The timeline indicating the various days of interest is shown displayed along the horizontal direction. The timeline is shown indicating the months (such as “April '13” and “May '13”) and the corresponding days (Monday, Tuesday, etc.) of interest in each of the months. It may be observed that common non-working days such as Saturdays and Sundays are shown as cross-hatched regions to indicate all the resources are not available during such days. It should be noted that the granularity of the timeline is assumed to be half-days, though only days are shown in display area 320 for convenience.

Display area 320 also displays the various tasks of the project below the timeline. Each task is shown in the form of a rectangle with the name of the task (such as “T01”, “T02” etc.) and the name of the resource (such as “Mike”, “Dona”, etc.) assigned to the task shown in the middle of the rectangle. Each rectangle is shown between the corresponding start dates and finish dates of the task. The values of the start and finish dates of a task indicates the planned date/time at which the task is to be respectively started and completed. The width (along the horizontal direction) of the rectangle indicates the duration of the corresponding task (in number of days).

Thus, the interface of FIG. 3A depicts various tasks of a project along a timeline. It may be appreciated that positions of the tasks T01-T08 may represent either the initial or final positions of the tasks along the timeline.

Management tool 150 may thereafter receive a candidate position for a task along the timeline of FIG. 3A. Such a candidate position may be received in response to a user desiring to find a suitable placement for a new task sought to be added to the timeline or moving one of the existing tasks (T01 to T08) along the timeline. The manner in which management tool 150 provides control to the user (of end user system 160A) in the placement of a task is described below with examples.

### 5. Placement of a New Task

Referring to FIG. 3B, display area 325 depicts a scrolled up portion of display area 320, as indicated by the vertical scroll bar shown there. Accordingly, display area 325 shows only a few of the tasks (T06, T07, etc.) from the timeline shown in display area 320. However, it should be noted that the other non-visible tasks (such as T01, T02, etc.) are still present along the timeline.

Task T09 (having a duration of two days) placed at a candidate position spanning April 30 and May 1, is shown as display item 330. Task T09 is described as being a new task (i.e., does not exist in the task data and accordingly not shown in the timeline of FIG. 3A), though the description is also applicable to moving a pre-existing task (T01-T08).

As noted above, the candidate position may be specified by a user using a pointing device (such as a mouse, or a finger on a touch based display) associated with end user system 160A, and the corresponding data is received by management tool 150. For example, the user may use the pointing device to drag the new task T09 from another view (not shown) to the timeline of FIG. 3A.

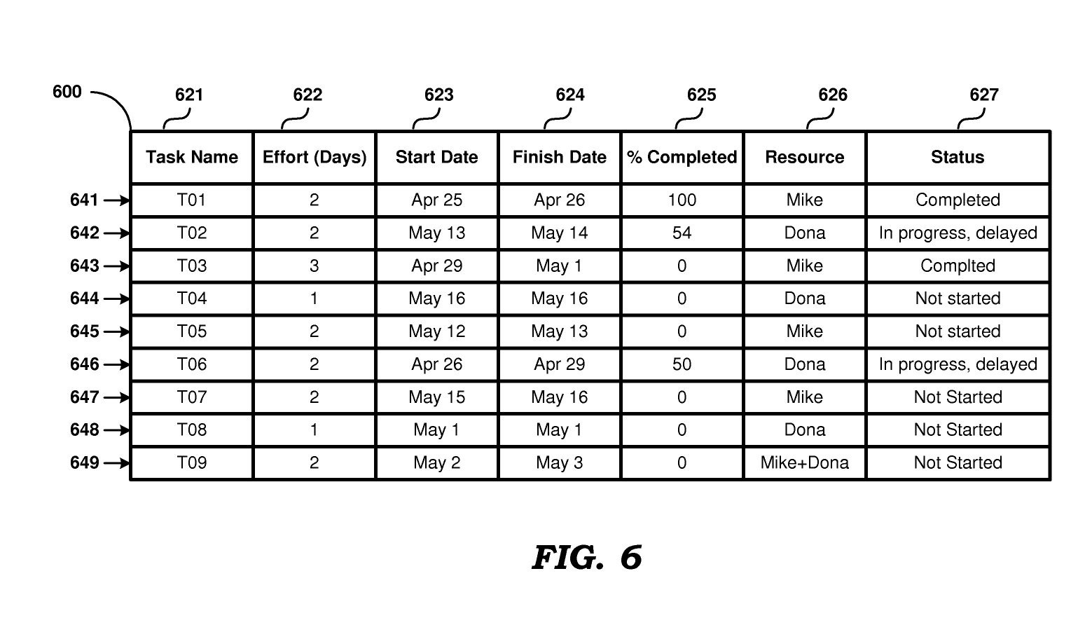

In response to receiving the candidate position at display item 330, management tool 150 examines a task data (portions of which are described below with respect to FIG. 6) to identify tasks scheduled in a time slice covering the candidate position. The begin and end dates of the time slice may be chosen in any convenient manner. In one embodiment, the time slice has a begin date three days prior to the start date of the candidate position, and an end date three days after the finish date of the candidate position. The time slice is further defined to be symmetrical around the candidate position.

Thus, for the candidate position of task T09 at display item 330, the time slice is chosen to have a begin date of April 27 (3 days prior to April 30) and an end date of May 4 (3 days after May 1). As such, the time slice is chosen to have a width of 8 days symmetrical about the center of candidate position 330 of new task T09. Management tool 150 accordingly identifies tasks T03, T06, and T08 as the tasks scheduled (either completely or partially) within the time slice of April 27 to May 4.

Management tool 150 then collects data (values of decision support parameters) related to the identified tasks in the time slice noted above. The data may include the number/detail of tasks contained in the time slice, the dependencies among the tasks in the time slice, the allocation of general/specific resources in the time slice, etc. The values may be collected for each day or as per the as per the granularity of the timeline (here, half-day).

Such decision support parameters may include parameters that are computed based on one or more collected parameters. For example, the capacity of the resources (per day/half-day) may be computed based on the collected values for the allocation of resources in the time slice. Management tool 150 then displays the collected data in a viewport as described below with examples.

### 6. Displaying Collected Data in a Viewport

Referring to FIG. 3C, viewport 350 represents a rectangular portion of display area 300 in which the data collected by management tool 150 (in response to the placing of task T09 at the candidate position of display item 330) is displayed to the user. Broadly, the values for each decision support parameter in the time slice are displayed in a corresponding section, with the collected/computed values displayed per half-day for the convenience of the user. Half-day represents a time unit equaling the granularity of timeline, though a different time unit may be used, as suitable in the corresponding environment. In addition, viewport 350 has display attributes (e.g., location, context, etc.), which visually associate viewport 350 to candidate position 330.

Thus, each of sections 341-343 provides the values per half-day for the corresponding decision support parameters. Section 341 “Labor Capacity” indicates for each half-day in the time slice, a rational number specifying the number of resources allocated (numerator) and the number of resources that are available (denominator). Section 342 “Nearby Tasks” indicates the tasks that scheduled within the time slice. It may be observed that section 342 includes tasks (such as T03) that are currently not visible in display area 325 due to the limited length of display area 325. Section 343 “Labor-wise Utilization” indicates the allocations for each resource (with M representing “Mike” and D representing “Dona”) in the time slice.

A user may click on/select button 344 to add new sections/decision support parameters of interest to be displayed in viewport 350. The user may also click/select button 345 to scroll the sections in the vertical direction, and accordingly view additional (currently non-visible) sections in viewport 350. Example of such additional sections/decision support parameters that may be displayed in viewport 350 may include but are not restricted to “Dependency Info” indicating dependencies existing among the tasks scheduled in the time slice, “Labor capacity for Skill-A”, “Labor capacity for Skill-B” (where Skill-A and Skill-B are specific skills of interest), “Priority Task” (indicating the priority tasks within the time slice), “Task Density” and “Priority Task Density”, “Number of Over-allocated Resources”, “Number of Milestone Tasks” etc.

While the above examples generally characterize the tasks identified in the time slice, it may be appreciated that decision support parameters unrelated to tasks inherently also may be displayed, to aid the user in deciding the placement of the task. An example of such a decision support parameter is weather forecast during the time slice. In an embodiment, the forecast details such as temperature, humidity, expected probability of rain, etc., may be displayed for each time unit (half-day).

Furthermore, an aspect of the present disclosure facilitates the user to change the width (and accordingly the start and finish dates) of the time slice. Referring to FIG. 3D, display area 360 depicts viewport 350 in response to a user selecting (using a pointing device such as a mouse) the right vertical edge of the viewport and dragging the edge towards the right (that is, increasing the width) by 2 days, as indicated by the double headed arrow 365. It may be observed that viewport 350 is shown to be width of 12 days (that is increased by 4 days, twice the user specified reduction) to ensure that the viewport maintains symmetry about the (center of) the candidate position of task T09.

A user may similarly increase/decrease the width of viewport 350 displaying the collected data/decision support parameters. In general, the size and/or location of viewport 350 is automatically adjusted such that the viewport 350 is centered on the task (T09) that the user is moving interactively (i.e., changing start/finish date-time using the interfaces of FIGS. 3A-3F).

It may be appreciated that the width of viewport 350 is shown to be the same as the width of the time slice analyzed by management tool 150 for illustration. However, in alternative embodiments, the widths of the viewport and time slice may be different and may be chosen according to the requirements of the environment, as will be apparent to one skilled in the relevant arts by reading the disclosure herein.

Thus, a user in enabled to view relevant information related to the nearby tasks of the new task (T09) at the proposed candidate position 330. The user, upon viewing the information shown in viewport 350 of FIG. 3C/3D, may identify that the specific resource “Mike” is not available at the candidate position 330 (as indicated under section 343 “Labor-wise Utilization”) and may accordingly wish to change the position of the new task. The manner in which a user is enabled to change positions and to decide on a selected position for the new task T09 is described below with examples.

### 7. Deciding on the Selected Position for a New Task

Referring to FIG. 3E, display item 335 depicts a new candidate position for the new task T09 (in lieu of the candidate position of display item 330) received from the user (using end user system 160A). The new candidate position may be specified by a user by clicking/selecting (using a pointing device such as a mouse) task T09 in FIGS. 3C/3D and then dragging task T09 to the new candidate position at display item 335.

Management tool 150, in response to the candidate position at display item 335, collects the data related to the tasks in a new time slice of 12 days (symmetrical about display item 335) and then displays the collected information in viewport 350. As such, viewport 350 of FIG. 3D is shown updated with the information on the nearby tasks of task T09 within the new time slice.

It may be observed that the information under section 343 “Labor-wise Utilization” in viewport 350 of FIG. 3E indicates that the specific resource “Mike” is available for allocation to the new task T09 for the current candidate position. The user may accordingly decide that the current candidate position 335 of new task T09 as the selected position at which task T09 is to be added to the task data. It may be appreciated that a user may similarly indicate different candidate positions for a task (T09), view the data of interest provided in the viewport (350) for the different candidate positions and then decide the selected position based on the data displayed at the different candidate positions.

After selecting a suitable position for a task T09, the user may also indicate the specific resource (here, ‘Mike’) to be assigned to the task. The assignment/allocation may be performed in a known way using an appropriate user interface. For example, the user may drag (using a pointing device) display item 335 and drop the item on the first row in “Labor-wise Utilization” section marked with “M” for the resource “Mike”. Thus, the user is enabled to select both the location (start/finish date), and also the assignment (labor resource assignment) for a new task using viewport 350.

Referring to FIG. 3F, display area 380 provides a timeline of the various tasks in the project after the placement of new task T09. It may be observed that the task T09 is shown placed at the selected position of display item 335. The task T09 is also shown to be allocated to the resource “Mike”. Thus, a user (using end user system 160A) is provided enhanced control in the placement of tasks (such as T09) along the timeline shown in FIG. 3A/3E.

As noted above, the approach of FIGS. 3C-3F may be used for moving a pre-existing task to a new position. However, pre-existing tasks may be moved for other reasons as well. For example, the user may wish to move some of the existing tasks to accommodate addition of a new task (such as T09) at a desired position along the timeline. An aspect of the present invention facilitates a user to conveniently move existing tasks identified in the time slice, while placing tasks in accordance the features of the disclosure described above.

### 8. Moving Existing Tasks to Accommodate a Desired Position for a Task Being Placed

For illustration, the description is continued starting from FIG. 3E (i.e., disregarding the placement shown in FIG. 3F). With respect to FIG. 3E, it is assumed that the user wishes to assign new task T09 to both the resources Mike and Dona. However, it may be observed that the resource Dona is not available for the candidate position 335. Accordingly, the user may wish to move pre-existing task T08 (allocated to Dona) to another position along the timeline.

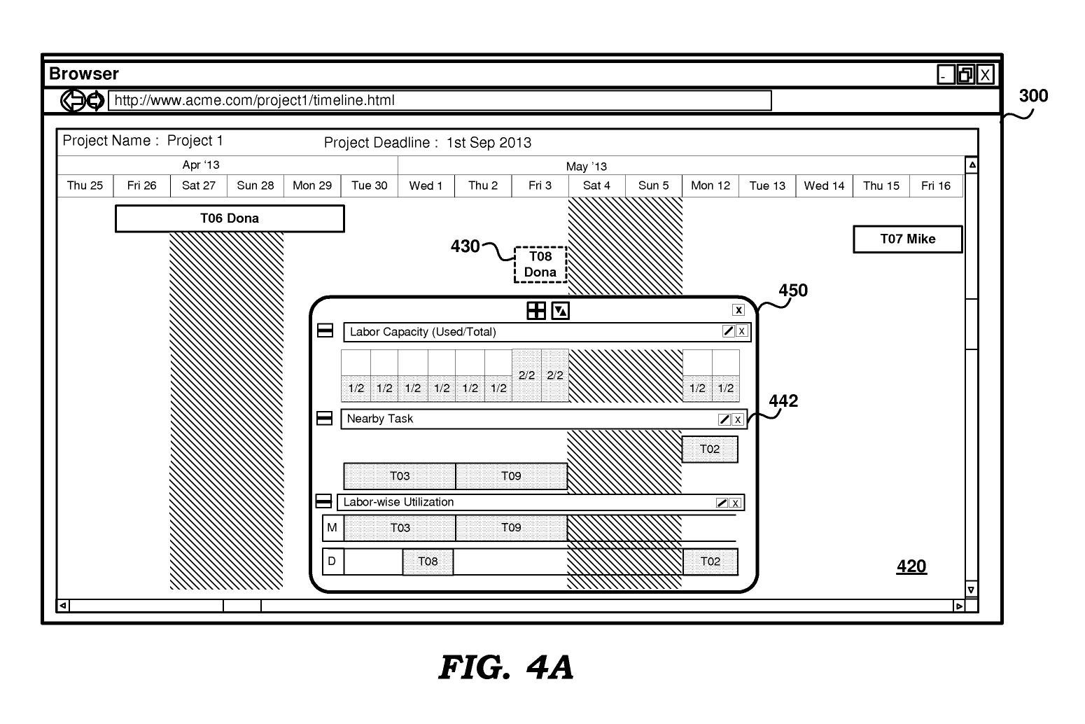

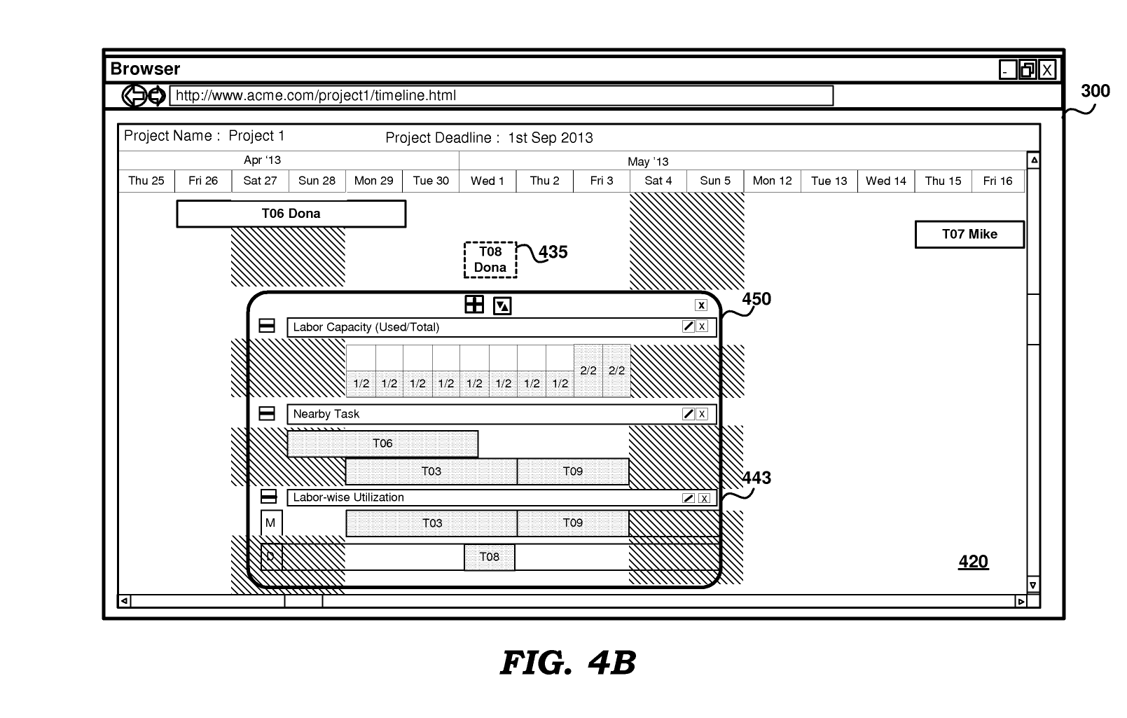

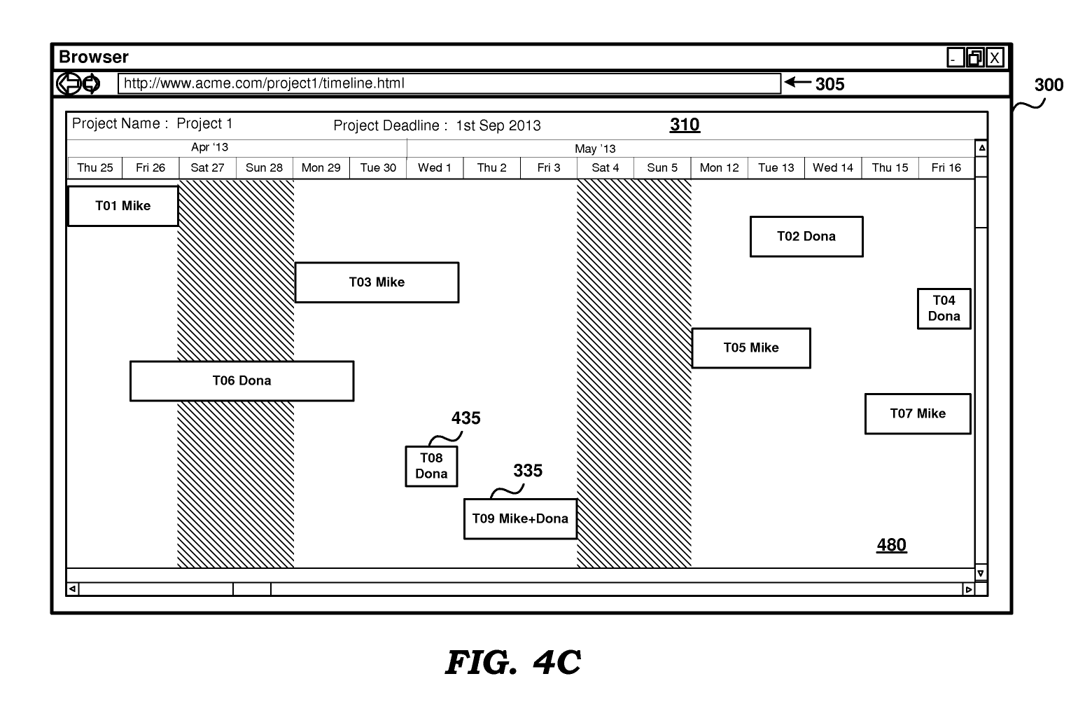

To initiate such a move, the user may select/click (using a pointing device such as a mouse) the task T08 (for Dona) shown in section 342 of viewport 350 in FIG. 3E. The display of FIG. 4A is provided as a result. The user may thereafter use the interfaces of FIGS. 4A-4C to allocate task T09 to both Mike and Dona.

FIGS. 4A-4C together illustrates the manner in which a user is enabled to move an existing task along a timeline in the above context, in one embodiment. As noted above, display area 300 of FIGS. 4A-4C depicts a portion of a user interface provided on a display unit associated with end user system 160A.

Referring to FIG. 4A, display area 420 provides a timeline of various tasks in the project. Display area 420 is similar to display area 325 and depicts a scrolled up portion of display area 320 of FIG. 3A. Display item 430 depicts a candidate position (as indicated by the dotted rectangle) of an existing task T08 sought to be moved by the user.

In response to the user selecting task T08 in section 342, management tool 150 adds (temporarily) the new task T09 to the timeline, and identifies that the existing task T08 is sought to be controlled/moved. Management tool 150 accordingly forms a new time slice with a width of 7 days (3 days on either side of task T08), identifies tasks schedules in the time slice, and collects data/values based on the identifier tasks and time slice.

Viewport 450 represents a rectangular portion of display area 300 in which the data collected by management tool 150 (in response to the selection of existing task T09 at display item 430) is displayed to the user. It may be observed that task T09 is shown as being (temporarily) added to the timeline/task data in section 442 of viewport 450. For convenience, viewport 450 is shown displaying the same sections/decision support parameters as in viewport 350. However, in alternative embodiments, a different set of sections/decision support parameters specific to moving of existing tasks may be displayed in place of/in addition to the sections shown while adding new tasks.

Referring to FIG. 4B, display item 435 depicts a new candidate position for the existing task T08 (in lieu of the candidate position of display item 430) received from the user (using end user system 160A). The new candidate position may be specified by a user by clicking/selecting (using a pointing device such as a mouse) task T08 in FIG. 4A and then dragging the task T08 to the new candidate position at display item 435.

Management tool 150, in response to the candidate position at display item 435, collects the data related to the tasks in a new time slice of 7 days (symmetrical about display item 435) and then displays the collected information in viewport 450. As such, viewport 450 of FIG. 4B is shown updated with the information on the nearby tasks of task T08 within the new time slice.

It may be observed that the information under section 443 “Labor-wise Utilization” in viewport 450 of FIG. 4B indicates that by moving the task T08 to display item 435, the specific resource “Dona” is made available for allocation to the new task T09 on May 2 and May 3. The user may accordingly decide that the current candidate position 435 of existing task T08 as the selected position to which task T08 is to be moved along the timeline. The user may thereafter assign the task “T09” to “Dona” as well, for example, by dragging and dropping display item 335 onto the second row of the “Labor-wise Utilization” section marked with “D” for Dona. Accordingly, the user is enabled to select additional labor resource assignments using viewport 350. However, in alternative embodiment, any other type of interaction (for example allowing the user to type in labor resource name through keyboard, etc.) may be provided to users for specifying labor resource assignments for a task, as suited to the specific environment, as will be apparent to one skilled in the relevant arts.

Referring to FIG. 4C, display area 480 provides a timeline of the various tasks in the project after the moving of existing task T08 and the placement of new task T09 along the timeline of FIG. 3A. It may be observed that the existing task T08 is shown moved to the selected position at display item 435, while new task T09 is shown placed at the selected position of display item 335. The new task T09 is also indicated to be allocated to both the resources Mike and Dona. Thus, a user (using end user system 160A) is provided enhanced control in the movement of existing tasks (such as T08) along the timeline shown in FIG. 3A/3E.

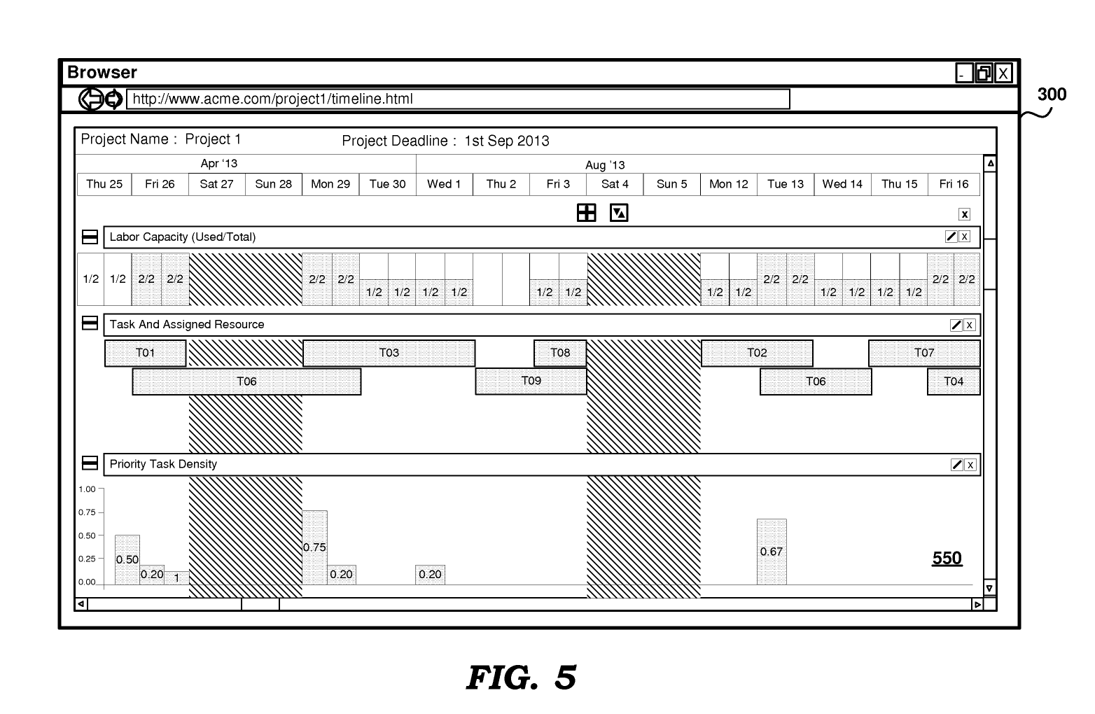

According to an aspect of the present invention, the viewport displaying the collected data may be shown in full view with all the tasks in the timeline. Referring to FIG. 5, display area 550 depicts a viewport that is shown in full view, whereby display area 550 occupies the full display available to the user and replaces the normal task view 480 of FIG. 4C. Such a full view is useful to review all the “confirmed” placements and allocations for a project (or a group of tasks), and to determine any “issues” (for example, over-allocation of a resource, densely populated priority tasks, violation of any dependencies, etc.) with the “confirmed” placements. It should be noted that such as full view (display area 550) is not suitable for adding new tasks or moving existing tasks (and for such actions, the user is required to use the interface of FIGS. 3A-3E and 4A-4C).

Thus, a user is provided enhanced control in the placement of tasks along a timeline. It may be appreciated that the features of the present disclosure are provided based on a task data maintained by management tool 150. A sample task data that may be maintained is described below with examples.

### 9. Task Data

FIG. 6 illustrates the manner in which task data is maintained in one embodiment. For illustration, it is assumed that data store 120 is implemented as a database server and accordingly the task data is maintained in the form of table 600 in a database in the database server. However, in alternative embodiments, the management data may be maintained in any other format such as XML (Extensible Markup Language), as will be apparent to one skilled in the relevant arts by reading the disclosure herein.

Table 600 depicts a portion of task data maintained in data store 120 corresponding to a time instance after FIG. 4C (disregarding the allocation of FIG. 3E, as also noted above). Column 621 (“Task Name”) specifies a unique identifier for each task. Column 622 (“Effort (Days)”) specifies the total effort in days allocated for each task. Columns 623 (“Start Date”) and 624 (“Finish Date”) specifies the corresponding start and finish time (in particular, the dates) for each task. Column 625 (“Resource”) specifies the name of the resource allocated to each task. Column 626 (“Status”) specifies the current status of each task.

Each of rows 641-649 specifies the details of a corresponding task represented in the timeline. In particular, row 641 specifies that the task named T01 requires a total effort of 2 days, starts from “April 25” and finishes on “April 26”, is allocated to resource “Mike”, and the status is “Completed”. Similarly the other rows specify the details of other tasks (T02 through T09) shown in display area 480 of FIG. 4C.

It may be observed that rows 641-647 represent the final positions of the corresponding tasks, with the status further updated to reflect the current state of execution of the task. On the other hand, rows 648 and 649 represent the initial positions of tasks T08 and T09, in accordance with the allocation in FIG. 4C. A scheduler may thereafter determine the final positions of tasks T08 and T09.

Thus, the task data is maintained in the form of table 600 in a database in data store 120. Though not shown, dependency data indicating the dependencies among the tasks of table 600 may be similarly specified, for example as another column in table 600 or as another table in the database. Management tool 150 inspects the data of table 600 to identify the tasks within a time slice and also the values for different decision support parameters (for example, the labor capacity based on the dates specified in column 623 and 624.

It should be appreciated that the features described above can be implemented in various embodiments as a desired combination of one or more of hardware, executable modules, and firmware. The description is continued with respect to an embodiment in which various features are operative when executable modules are executed.

### 10. Digital Processing System

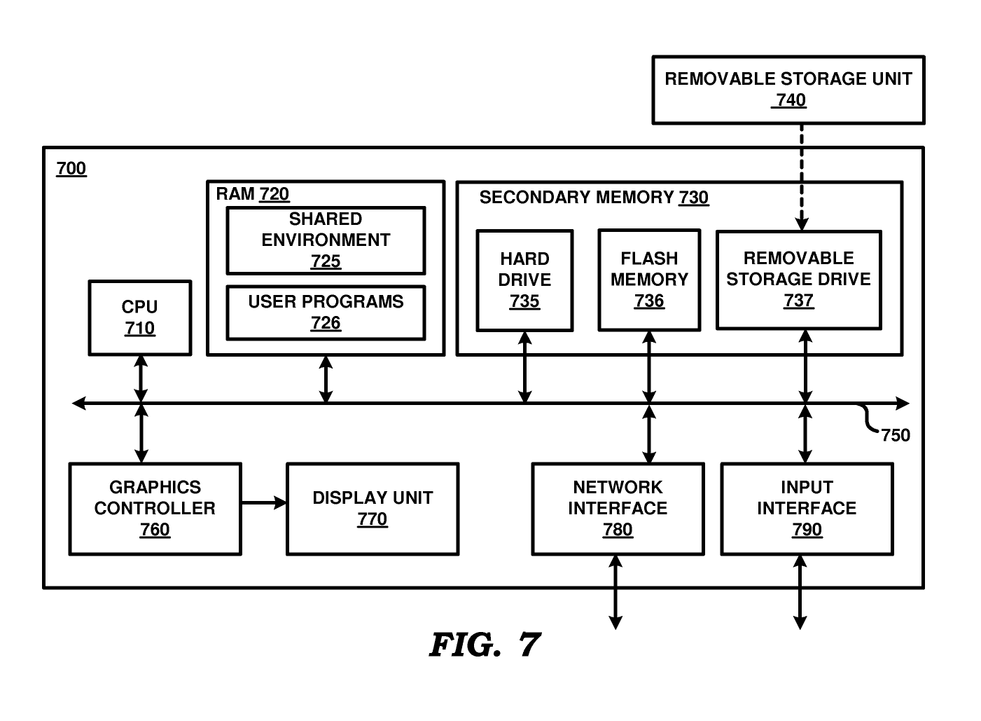

FIG. 7 is a block diagram illustrating the details of digital processing system 700 in which various aspects of the present disclosure are operative by execution of appropriate executable modules. Digital processing system 700 may correspond to any system (such as server system 130) executing management tool 150.

Digital processing system 700 may contain one or more processors such as a central processing unit (CPU) 710, random access memory (RAM) 720, secondary memory 730, graphics controller 760, display unit 770, network interface 780, and input interface 790. All the components except display unit 770 may communicate with each other over communication path 750, which may contain several buses as is well known in the relevant arts. The components of FIG. 7 are described below in further detail.

CPU 710 may execute instructions stored in RAM 720 to provide several features of the present disclosure. CPU 710 may contain multiple processing units, with each processing unit potentially being designed for a specific task. Alternatively, CPU 710 may contain only a single general-purpose processing unit.

RAM 720 may receive instructions from secondary memory 730 using communication path 750. RAM 720 is shown currently containing software instructions constituting operating environment 725 and/or other user programs 726 (such as the instances of task management software, etc.). In addition to operating environment 725, RAM 720 may contain other software programs such as device drivers, virtual machines, etc., which provide a (common) run time environment for execution of other/user programs.

Graphics controller 760 generates display signals (e.g., in RGB format) to display unit 770 based on data/instructions received from CPU 710. Display unit 770 contains a display screen to display the images defined by the display signals. Each of the displays shown in FIGS. 3A-3F, 4A-4C and 5 corresponds to an image screen displayed at corresponding time duration on the display screen. Input interface 790 may correspond to a keyboard and a pointing device (e.g., touch-pad, mouse) and may be used to provide inputs (such as those provided by the users using the interfaces of FIGS. 3A-3F, 4A-4C and 5 as described above). Network interface 780 provides connectivity to a network (e.g., using Internet Protocol), and may be used to communicate with other systems connected to the network (such as end user systems 160A-160X, server system 130, etc.).

Secondary memory 730 may contain hard drive 735, flash memory 736, and removable storage drive 737. Secondary memory 730 may store the data (for example, portions of the data shown in FIG. 6) and software instructions (for implementing the steps of FIG. 2), which enable digital processing system 700 to provide several features in accordance with the present disclosure. The code/instructions stored in secondary memory 730 may either be copied to RAM 720 prior to execution by CPU 710 for higher execution speeds, or may be directly executed by CPU 710.

Secondary memory 730 may contain hard drive 735, flash memory 736, and removable storage drive 737. Some or all of the data and instructions may be provided on removable storage unit 740, and the data and instructions may be read and provided by removable storage drive 737 to CPU 710. Removable storage unit 740 may be implemented using medium and storage format compatible with removable storage drive 737 such that removable storage drive 737 can read the data and instructions. Thus, removable storage unit 740 includes a computer readable (storage) medium having stored therein computer software and/or data. However, the computer (or machine, in general) readable medium can be in other forms (e.g., non-removable, random access, etc.).

In this document, the term “computer program product” is used to generally refer to removable storage unit 740 or hard disk installed in hard drive 735. These computer program products are means for providing software to digital processing system 700. CPU 710 may retrieve the software instructions, and execute the instructions to provide various features of the present disclosure described above.

The term “storage media/medium” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage memory 730. Volatile media includes dynamic memory, such as RAM 720. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 750. Transmission media can also take the form of acoustic or light waves, such as those generated during radio-wave and infra-red data communications.

Reference throughout this specification to “one embodiment”, “an embodiment”, or similar language means that a particular feature, structure, or characteristic described in connection with the embodiment is included in at least one embodiment of the present disclosure. Thus, appearances of the phrases “in one embodiment”, “in an embodiment” and similar language throughout this specification may, but do not necessarily, all refer to the same embodiment.

Furthermore, the described features, structures, or characteristics of the disclosure may be combined in any suitable manner in one or more embodiments. In the above description, numerous specific details are provided such as examples of programming, software modules, user selections, network transactions, database queries, database structures, hardware modules, hardware circuits, hardware chips, etc., to provide a thorough understanding of embodiments of the disclosure.

### 11. Conclusion

While various embodiments of the present disclosure have been described above, it should be understood that they have been presented by way of example only, and not limitation. Thus, the breadth and scope of the present disclosure should not be limited by any of the above-described exemplary embodiments, but should be defined only in accordance with the following claims and their equivalents.

It should be understood that the figures and/or screen shots illustrated in the attachments highlighting the functionality and advantages of the present disclosure are presented for example purposes only. The present disclosure is sufficiently flexible and configurable, such that it may be utilized in ways other than that shown in the accompanying figures.

Further, the purpose of the following Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract is not intended to be limiting as to the scope of the present disclosure in any way.

What is claimed is:

1. A method of providing enhanced control to users in the placement of tasks along timelines, said method comprising:
maintaining task data specifying details of a plurality of tasks scheduled along a timeline;
sending for display said plurality of tasks along said timeline;
receiving a candidate position for a first task along said timeline;
examining said task data to identify a set of tasks scheduled in a time slice covering said candidate position, said set of tasks being contained in said plurality of tasks;
collecting data related to said set of tasks; and
sending for display said collected data.

2. The method of claim 1, further comprising:
receiving a sequence of candidate positions for said first task along said timeline, said sequence including said first position;
performing said examining, said collecting and said sending for display, for each of said sequence of candidate positions;
receiving an indication that a last candidate position of said sequence of candidate positions represents a selected position for said first task along said timeline; and
adding said first task at said selected position to said task data.

3. The method of claim 2, further comprising executing a scheduler to determine a final position for said first task along said time line, wherein said scheduler determines said final position based on said selected position.

4. The method of claim 2, wherein said collected data comprises values for a set of decision support parameters that aid in deciding suitability of said candidate position for said first task along said time line,
wherein said collected data is sent for display in a viewport associated with said first task.

5. The method of claim 4, wherein said decision support parameters comprise labor capacity, nearby tasks and labor-wise utilization,
wherein said labor capacity indicates a ratio of number of allocated resources to the total number of resources for each time unit of a sequence of time units constituting said time slice,
wherein said nearby tasks specify a list of tasks scheduled in said time slice, and
wherein said labor-wise utilization indicates for each resource, whether or not the resource is allocated in the corresponding time unit of said sequence of time units.

6. The method of claim 4, wherein said collecting collects a second decision support parameter related to said time slice, wherein said second decision support parameter comprises weather forecast in said time slice.

7. The method of claim 5, further comprising:
receiving a selection of a second task of said set of tasks, wherein said second task is one of said nearby tasks displayed in said viewport;
performing said examining, said collecting and said sending for display with said candidate position set to a current position of said second task along said timeline,
wherein said collected data is sent for display in said viewport now shown associated with said second task.

8. The method of claim 7, wherein said first task is at a first candidate position when said selection of said second task is received, said method further comprising:
receiving a second selected position for said second task along said time line; and
adding said second task at said second selected position and said first task at said first candidate position to said task data, upon receiving said second selected position.

9. A non-transitory machine readable medium storing one or more sequences of instructions for enabling a system to provide enhanced control to users in the placement of tasks along timelines, wherein execution of said one or more instructions by one or more processors contained in said system enables said system to perform the actions of:
maintaining task data specifying details of a plurality of tasks scheduled along a timeline;
sending for display said plurality of tasks along said timeline;
receiving a candidate position for a first task along said timeline;
examining said task data to identify a set of tasks scheduled in a time slice covering said candidate position, said set of tasks being contained in said plurality of tasks;
collecting data related to said set of tasks; and
sending for display said collected data.

10. The machine readable medium of claim 9, further comprising one or more instructions for:
receiving a sequence of candidate positions for said first task along said timeline, said sequence including said first position;
performing said examining, said collecting and said sending for display, for each of said sequence of candidate positions;
receiving an indication that a last candidate position of said sequence of candidate positions represents a selected position for said first task along said timeline; and
adding said first task at said selected position to said task data.

11. The machine readable medium of claim 10, further comprising one or more instructions for executing a scheduler to determine a final position for said first task along said time line, wherein said scheduler determines said final position based on said selected position.

12. The machine readable medium of claim 10, wherein said collected data comprises values for a set of decision support parameters that aid in deciding suitability of said candidate position for said first task along said time line,
wherein said collected data is sent for display in a viewport associated with said first task.

13. The machine readable medium of claim 12, wherein said decision support parameters comprise labor capacity, nearby tasks and labor-wise utilization,
wherein said labor capacity indicates a ratio of number of allocated resources to the total number of resources for each time unit of a sequence of time units constituting said time slice,
wherein said nearby tasks specify a list of tasks scheduled in said time slice, and
wherein said labor-wise utilization indicates for each resource, whether or not the resource is allocated in the corresponding time unit of said sequence of time units,
wherein said collecting further collects a second decision support parameter related to said time slice, wherein said second decision support parameter comprises weather forecast in said time slice.

14. The machine readable medium of claim 13, further comprising one or more instructions for:
receiving a selection of a second task of said set of tasks, wherein said second task is one of said nearby tasks displayed in said viewport;
performing said examining, said collecting and said sending for display with said candidate position set to a current position of said second task along said timeline,
wherein said collected data is sent for display in said viewport now shown associated with said second task.

15. The machine readable medium of claim 14, wherein said first task is at a first candidate position when said selection of said second task is received, further comprising one or more instructions for:
receiving a second selected position for said second task along said time line; and
adding said second task at said second selected position and said first task at said first candidate position to said task data, upon receiving said second selected position.

16. A digital processing system comprising:
a processor;
a random access memory (RAM);
a machine readable medium to store one or more instructions, which when retrieved into said RAM and executed by said processor causes said digital processing system to provide enhanced control to users in the placement of tasks along timelines, said digital processing system performing the actions of:
maintaining task data specifying details of a plurality of tasks scheduled along a timeline;
sending for display said plurality of tasks along said timeline;
receiving a candidate position for a first task along said timeline;
examining said task data to identify a set of tasks scheduled in a time slice covering said candidate position, said set of tasks being contained in said plurality of tasks;
collecting data related to said set of tasks; and
sending for display said collected data.

17. The digital processing system of claim 16, further performing the actions of:
receiving a sequence of candidate positions for said first task along said timeline, said sequence including said first position;
performing said examining, said collecting and said sending for display, for each of said sequence of candidate positions;
receiving an indication that a last candidate position of said sequence of candidate positions represents a selected position for said first task along said timeline; and
adding said first task at said selected position to said task data.

18. The digital processing system of claim 17, further performing the action of executing a scheduler to determine a final position for said first task along said time line, wherein said scheduler determines said final position based on said selected position.

19. The digital processing system of claim 18, wherein said collected data comprises values for a set of decision support parameters that aid in deciding suitability of said candidate position for said first task along said time line,
wherein said collected data is sent for display in a viewport associated with said first task.

20. The digital processing system of claim 19, further performing the action of:
receiving a selection of a second task of said set of tasks, wherein said second task is one of said nearby tasks displayed in said viewport;
performing said examining, said collecting and said sending for display with said candidate position set to a current position of said second task along said timeline,
wherein said collected data is sent for display in said viewport now shown associated with said second task.
